(19) United States
(12) Patent Application Publication
(10) Pub. No.: US 2010/0246065 A1
(43) Pub. Date: Sep. 30, 2010

(54) Suspension with additional bonding pads, head gimbal assembly and disk drive unit with the same

(75) Inventor: XianWen Feng, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics(H.K). Ltd., Hong Kong (CN)

(21) Appl. No.: 12/382,829

(22) Filed: Mar. 24, 2009

(51) Int. Cl. G11B 5/60; G11B 5/48

(52) U.S. Cl. 360/234.5; 360/245.4; G9B/5.229; G9B/5.147

(57) ABSTRACT

A suspension for a head gimbal assembly comprises a flexure having a plurality of electrical traces formed thereon, a plurality of first bonding pads formed on a first surface of the flexure and at least one second bonding pad formed on a second surface of the flexure opposite the first surface. The first bonding pads and the at least one second bonding pad are electrically connected with the electrical traces and adapted to electrically connect to a slider of the head gimbal assembly. The invention also discloses a head gimbal assembly and a disk drive unit with the same.

### FIELD OF THE INVENTION

The present invention relates to information recording disk drive devices and, more particularly, to a suspension having a flexure with additional bonding pads, head gimbal assembly (HGA) and disk drive unit with the same.

### BACKGROUND OF THE INVENTION

Hard disk drives are common information storage devices. Referring to FIG. 1a, a conventional disk drive 100 essentially consists of a series of rotatable disks 101 mounted on a spindle, and a Head Stack Assembly (HSA) 130 which is rotatable about an actuator arm axis 102 for accessing data tracks on disks during seeking. The HSA 130 includes at least one arm 104 and HGA 150.

Referring to FIG. 1b, the HGA 150 includes a slider 103 having a reading/writing transducer imbedded therein, a suspension 190 to load or suspend the slider 103 thereon. As illustrated, the suspension 190 includes a load beam 106, a base plate 108, a hinge 107 and a flexure 105, all of which are assembled together.

FIG. 1c shows a more detailed structure of the flexure 105. As illustrated in the figure, a plurality of suspension traces 120 is formed on the flexure 105 along length direction thereof. One end of the traces 120 is electrically connected to a preamplifier (not shown), and the other end thereof extends into the suspension tongue 136. The suspension tongue 136 is connected to a pair of cross bars 122 extending from two lateral sides thereof respectively. The cross bars 122 are further connected to a pair of struts 121 respectively, which are formed at distal end of the flexure 105. And the suspension tongue 136 has a leading edge limiter 123 provided at one end thereof and a trailing edge limiter 124 provided at the other end thereof for stably holding the slider 103 on the suspension tongue 136. A pair of grounding pads 125 is provided on the suspension tongue 136 adjacent the leading edge limiter 123 for effectively conducting static electricity to ground, thus preventing ESD (electric static discharge) problem. When the slider 103 is mounted on the suspension tongue 136 and electrically coupled with the other ends of the traces 120 by a plurality of bonding pads 126, the preamplifier controls the slider 103, thus realizing data reading/writing operation with respect to the disk.

Bonding pads of all prior gimbal designs are placed on a first surface of the flexure, as shown in FIG. 1c. Normally, there are four or six bonding pads on the first surface of the flexure. Due to the small room and size of the flexure, it is very difficult to place other bonding pads with additional functions on the first surface of the flexure and, in turn, the function or performance of the slider is limited.

Thus, there is a need for an improved suspension, HGA and disk drive unit that do not suffer from the above-mentioned drawbacks.

### SUMMARY OF THE INVENTION

One aspect of the present invention is to provide a suspension with more bonding pads formed thereon to connect with more components with special function, thus supporting more functions to the slider and further improving the performance of the slider.

Another aspect of the present invention is to provide a HGA with more bonding pads formed on the suspension thereof to connect with more components with special function, thus supporting more functions to the slider and further improving the performance of the slider.

Yet another aspect of the present invention is to provide a disk drive unit with more bonding pads formed on the suspension thereof to connect with more components with special function, thus supporting more functions to the slider and further improving the performance of the slider.

To achieve above objectives, a suspension for a HGA comprises a flexure having a plurality of electrical traces formed thereon, a plurality of first bonding pads formed on a first surface of the flexure and at least one second bonding pad formed on a second surface of the flexure opposite the first surface. The first bonding pads and the at least one second bonding pad are electrically connected with the electrical traces and adapted to electrically connect to a slider of the head gimbal assembly.

In comparison with the prior art, as the bonding pads can be formed on both surfaces of the flexure, more bonding pads can be provided to connect with more components with special function on the slider, thus supporting more functions to the slider and further improving the performance of the slider.

As an embodiment of the present invention, the electrical traces are formed on the first surface of the flexure, and the at least one second bonding pad is connected with the electrical traces by a conductive joint running through the flexure. For example, the conductive joints are copper joints.

As another embodiment of the present invention, electrical traces are formed on both the first surface of the flexure and the second surface of the flexure, the first bonding pads are electrically connected with the electrical traces formed on the first surface of the flexure, and the at least one second bonding pad is electrically connected with the electrical traces formed on the second surface of the flexure.

As still another embodiment of the present invention, the flexure comprises a stainless steel layer between the first surface and the second surface of the flexure, and insulate layers formed between the stainless steel layer and the first surface and the second surface respectively. Preferably, the insulate layer is made of polyimide.

As another embodiment of the present invention, the flexure comprises two second bonding pads, and the two second bonding pads are symmetrical about a centerline of the suspension.

As yet another embodiment of the present invention, the flexure further comprises cover layers formed on the first surface and the second surface of the flexure, respectively.

A HGA comprises a slider and a suspension with a flexure for supporting the slider. The suspension comprises a flexure having a plurality of electrical traces formed thereon, a plurality of first bonding pads formed on a first surface of the flexure and at least one second bonding pad formed on a second surface of the flexure opposite the first surface. The first bonding pads and the at least one second bonding pad are electrically connected with the electrical traces and adapted to electrically connect to a slider of the head gimbal assembly.

A disk drive unit comprises a HGA including a slider and a suspension that supports the slider, a series of rotatable disks mounted on a spindle; and an arm connected to the head gimbal assembly. The suspension comprises a flexure having a plurality of electrical traces formed thereon, a plurality of first bonding pads formed on a first surface of the flexure and at least one second bonding pad formed on a second surface of the flexure opposite the first surface. The first bonding pads and the at least one second bonding pad are electrically connected with the electrical traces and adapted to electrically connect to a slider of the head gimbal assembly.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive unit;

FIG. 1b is a perspective view of a conventional HGA;

FIG. 1c is a partial top plan view of a flexure of the HGA shown in FIG. 1b;

FIG. 2 is an exploded perspective view of a suspension according to an embodiment of the present invention;

FIG. 3 is a top plan view of a flexure of the suspension shown in FIG. 2;

FIG. 4a is an enlarged partial plan view of a first surface of the flexure shown in FIG. 3;

FIG. 4b is an enlarged partial plan view of a second surface of the flexure shown in FIG. 3;

FIG. 5 is a cross-sectional side view of the flexure shown in FIG. 4a taken along the line A-A of FIG. 4a;

FIG. 6 is a perspective view of a flexure of a suspension according to a second embodiment of the invention;

FIG. 7a is an enlarged partial plan view of a first surface of the flexure shown in FIG. 6;

FIG. 7b is an enlarged partial plan view of a second surface of a flexure shown in FIG. 6;

FIGS. 8a-8b respectively show a first surface and a second surface of a flexure of a suspension according to a third embodiment of the invention;

FIG. 9a is an enlarged partial plan view of the first surface of the flexure shown in FIG. 8a;

FIG. 9b is an enlarged partial plan view of the second surface of the flexure shown in FIG. 8b;

FIGS. 10a-10b respectively show a first surface and a second surface of a flexure of a suspension according to a forth embodiment of the invention;

FIG. 11a is an enlarged partial plan view of the first surface of the flexure shown in FIG. 10a;

FIG. 11b is an enlarged partial plan view of the second surface of a flexure shown in FIG. 10b;

FIG. 12 is a perspective view of a HGA according to an embodiment of the present invention; and

FIG. 13 is a perspective view of a disk drive unit according to an embodiment of the invention.

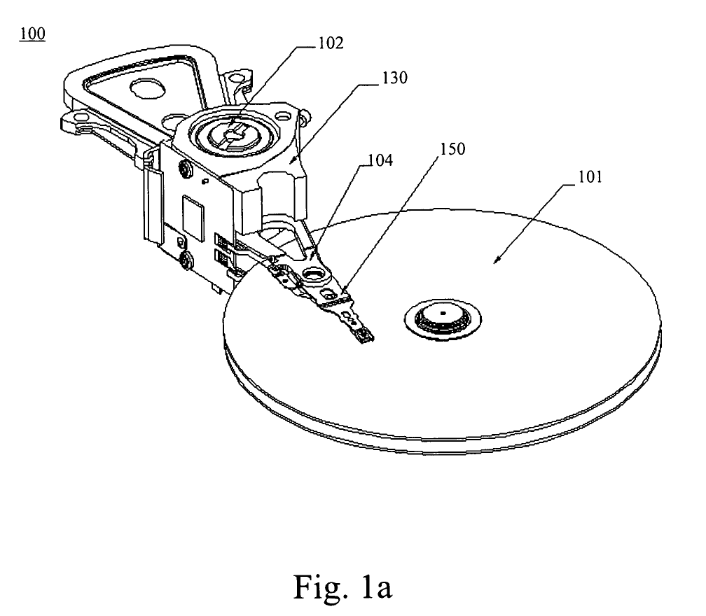

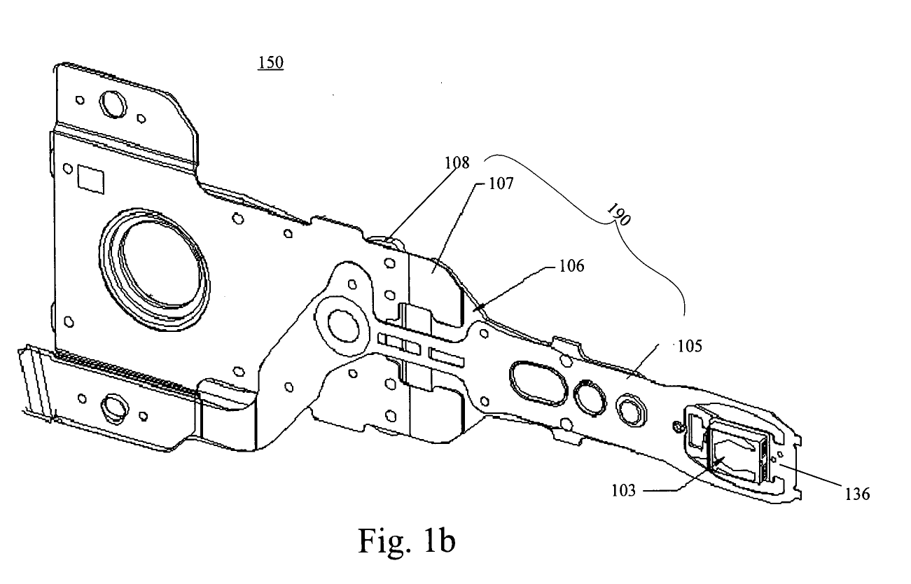

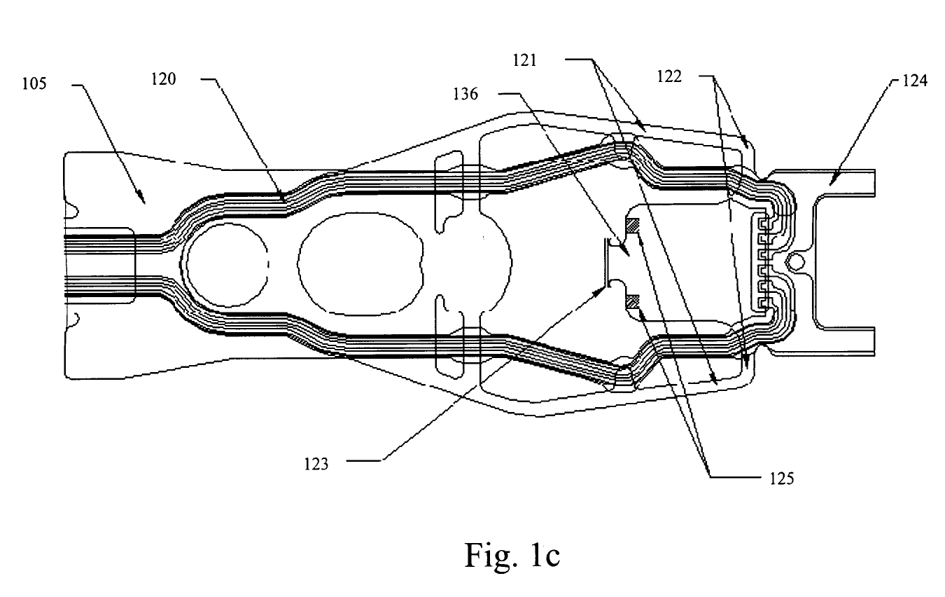

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a suspension for a HGA of a disk drive unit, which includes a flexure having additional bonding pads formed thereon. By providing more additional bonding pads, more components with special function can be connected to the HGA, thus improving reading/writing characteristics of the slider and performance of the entire disk drive device.

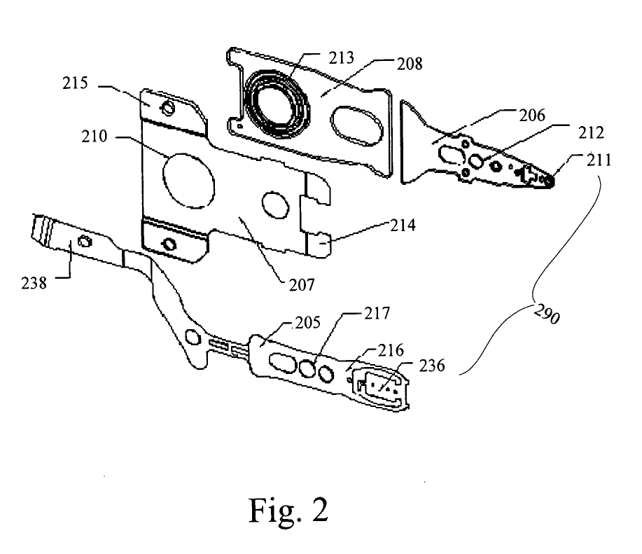

FIG. 2 shows an embodiment of a suspension of the present invention. As illustrated in FIG. 2, a suspension 290 including a load beam 206, a base plate 208, a hinge 207 and a flexure 205, all of which are assembled with each other.

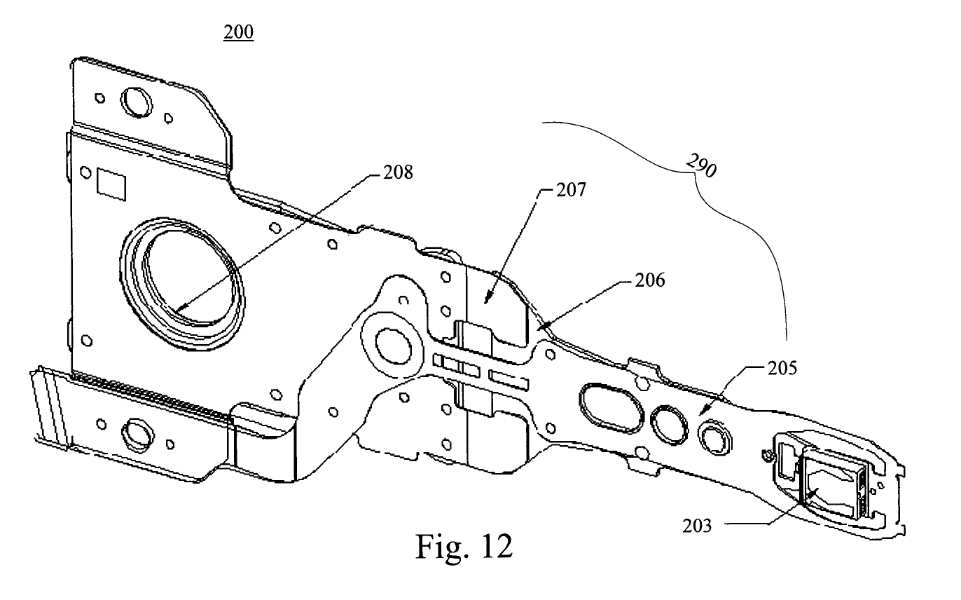

Referring to FIG. 2 and FIG. 12, the load beam 206 is used to transfer load forces to the flexure 205 and a slider mounted on the flexure 205. Any suitable rigid material such as stainless steel may be used to form the load beam 206 such that the load beam 206 has sufficient stiffness to transfer the load forces to the flexure 205. The load beam 206 is connected to the base plate 208 by the hinge 207. A locating hole 212 is formed on the load beam 206 for aligning itself with the flexure 205. A dimple 211 is formed on the load beam 206 to support the flexure 205 at a position corresponding to a center of the slider. By this engagement of the dimple 211 with the flexure 205, the load forces can be transferred to the slider uniformly.

The base plate 208 is used to enhance structure stiffness of the whole suspension 290 and may be made of rigid material such as stainless steel. A mounting hole 213 is formed on one end of the base plate 208 for mounting the whole suspension 290 to a motor arm of a disk drive unit.

The hinge 207 has a mounting hole 210 formed on its one end corresponding to the mounting hole 213 of the base plate 208, and the hinge 207 is partially mounted to the base plate 208 with the mounting holes 210, 213 aligned with each other. The hinge 207 and the base plate 208 may be mounted together by laser welding at a plurality of pinpoints 209 distributed on the hinge 207. In addition, two hinge steps 215 may be integrally formed at two sides of the hinge 207 at one end adjacent the mounting hole 210 for strengthening stiffness of the hinge 207. Two hinge struts 214 are extended from the other end of the hinge 207 to partially mount the hinge 207 to the load beam 206.

The flexure 205 is made of flexible material and runs from the hinge 207 to the load beam 206. The flexure 205 has a tail portion 238 adjacent the hinge 207 and a top portion 216 adjacent the load beam 206. A locating hole 217 is formed on the top portion 216 of the flexure 205 and is aligned with the locating hole 212 of the load beam 206. The perfect alignment between the locating holes 217 and 212 can assure a high assembly precision between the flexure 205 and the load beam 206. A gimbal tongue 236 is provided at the top portion 216 of the flexure 205 to support the slider 203 thereon.

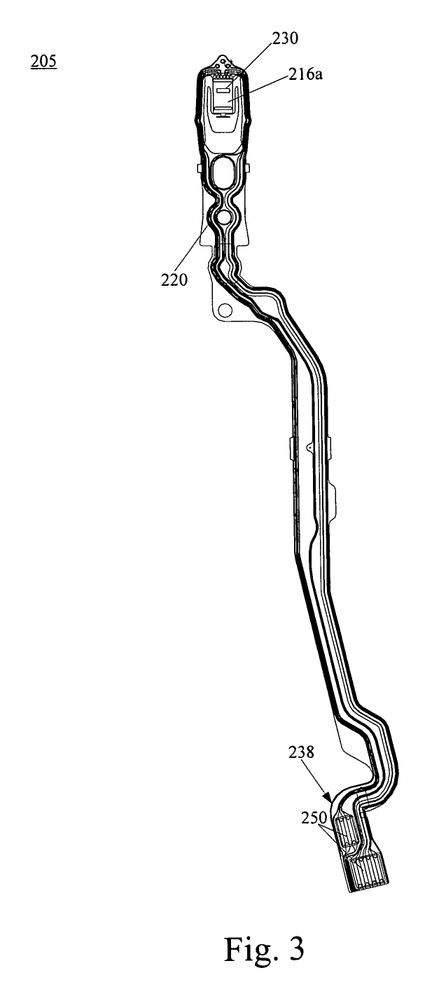

FIG. 3 illustrates a detail structure of the flexure 205. Referring to FIG. 3, the tail portion 238 has two bonding terminals 250 adapted for establishing electrical connection with a flexible printed cable (not shown), thus connecting with a control servo. The flexure 205 has a plurality of electrical traces 220 which run from the top portion 216 to the tail portion 238 formed thereon.

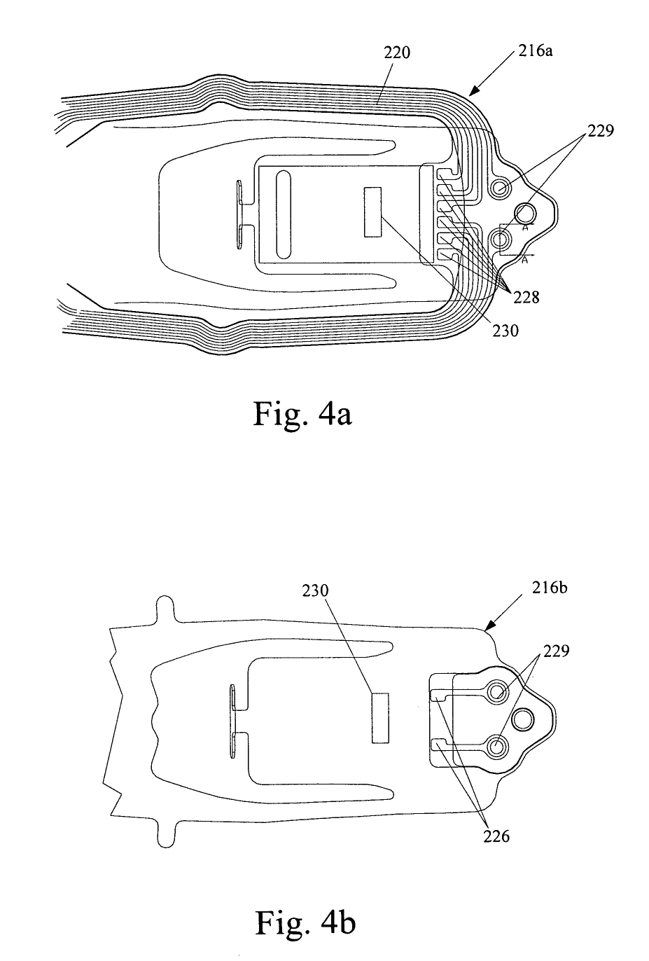

FIG. 4a shows the first surface 216a of the top portion 216 of the flexure 205, on which the slider is attached. FIG. 4b shows the second surface 216b of the top portion 216 of the flexure opposite the first surface 216a. Referring to FIGS. 4a-4b, a series of first bonding pads 228, such as six, formed on the first surface 216a of the flexure 205, and two second bonding pads 226 formed on a second surface 216b of the flexure 205. The first bonding pads 228 and two second bonding pads 226 are electrically connected with the electrical traces 220 and adapted to electrically connect to the slider of the HGA and, in turn, the slider is electrically connected with the control servo. Concretely, the second bonding pads 226 are connected with the electrical traces 220, all of which are formed on the first surface 216a of the flexure, by conductive joints running through the flexure. For example, the conductive joints are copper joints 229. The two copper joints 229 are symmetrical about a centerline of the suspension 290 in a longitudinal direction of the flexure. It should be noted that the number of the second bonding pads 226 can be varied depending on the actual requirement.

In some case, the slider may have a protrusion element (not shown) formed on the surface opposite to the air bearing surface (ABS) thereon such that extra components with special function can be embedded into the slider. Accordingly, a through hole 230 is formed on the suspension tongue next to the bonding pads 228, 226 to accommodate the protrusion element of the slider. When a slider is mounted on the suspension 290, the extra components on the protrusion element of the slider go beyond the second surface 216b of the flexure through the through hole 230. Then, the second bonding pads 226 serving as the connectors connect with the components to achieve some functions which may improve the slider's writing/reading performance.

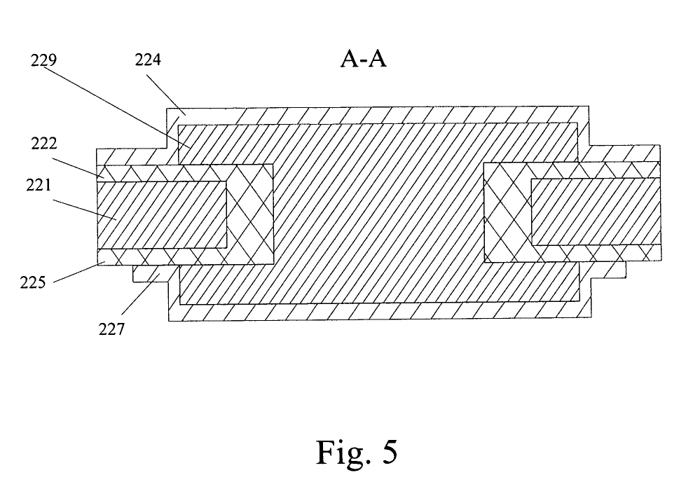

Referring to FIGS. 4a-4b again, in this embodiment, the second bonding pads 226 are connected with the traces 220 via the corresponding copper joints 229, which are at the same side with the second bonding pads 226 respectively relate to the center longitudinal axis of the flexure 205 (can not be seen in FIG. 4a). FIG. 5 is a cross-sectional side view of the flexure, taken along the line A-A of FIG. 4a, showing the structure of a position of the flexure at which the copper joint 229 runs through the flexure. As illustrated in FIG. 5, the flexure is formed of several layers. From the first surface 216a to the second surface 216b, they are a front side cover layer 224, a front side insulate layer 222, a stainless steel layer 221, a back side insulate layer 225 and a back side cover layer 227 respectively. There are several holes formed on the flexure, in which the coppers are filled to form the copper joints 229. The front side insulate layer 222 and the back side insulate layer 225 joint each other so as to separate the stainless steel layer 221 from the copper joints 229. Besides, the front side cover layer 224 is supported by the front side insulate layer 222 and covers one surface of the copper point 229. And the back side cover layer 227 is supported by the back side insulate layer 225 and covers the other surface of the copper point 229. By the copper points 229, the second bonding pads 226 on the second surface 216b of the flexure 205 may connect with the front side electrical traces 220. Preferably, the insulate layer 222 is made of polyimide.

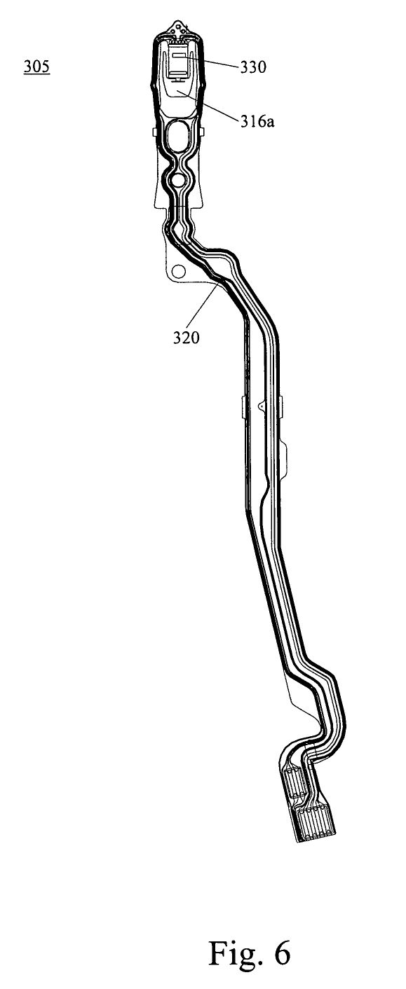

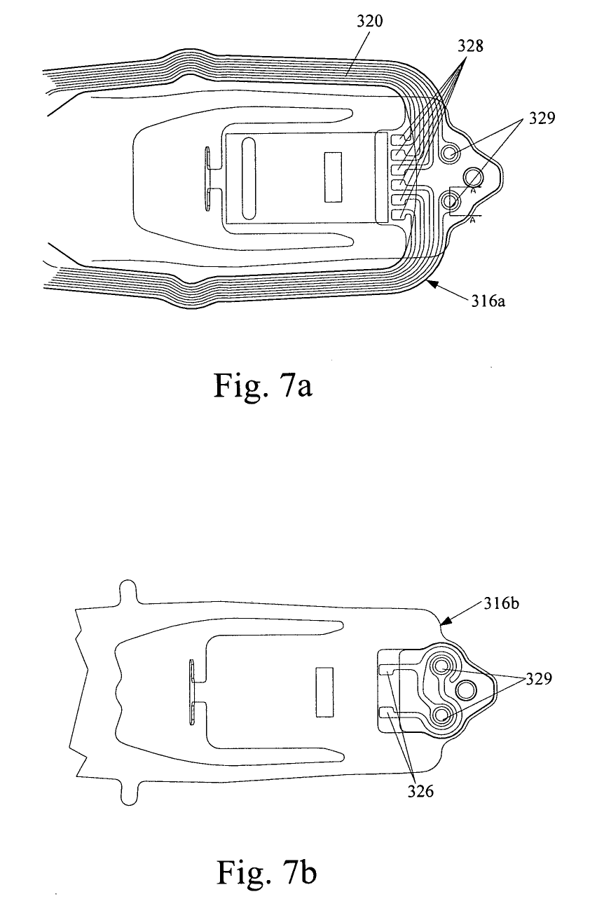

FIG. 6 and FIGS. 7a-7b illustrate a flexure of a suspension according to a second embodiment of the present invention. The structure of the flexure 305 of the second embodiment is similar to that of the flexure 205 of the first embodiment, except that the connection way between the second bonding pads 326 and the copper points 329. Referring to the FIG. 4b and FIG. 7b, in the first embodiment, every second bonding pad 226 connects with the copper joint 229 which is almost located in a line with the second bonding pad 226 along the longitudinal direction of the flexure, while in the second embodiment, the second bonding pads 326 respectively connect with the copper joints 329 which are located in front of another. A through hole 330 is formed on the suspension tongue next to the bonding pads 328, 326 to accommodate the protrusion element of the slider. When a slider is mounted on the suspension 290, the extra components on the protrusion element of the slider go beyond the second surface 316b of the flexure through the through hole 330.

Since the bonding pads can be formed on both surfaces 316a and 316b of the flexure 305, more bonding pads, that is the second bonding pads 326, can be provided to connect with more components with special function on the slider, thus supporting more functions to the slider and further improving the performance of the slider, finally improving the performance of the entire disk drive unit.

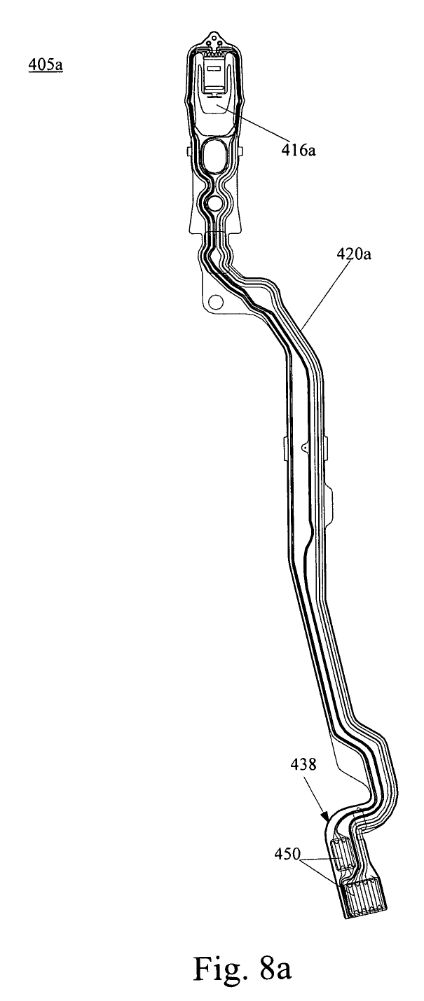

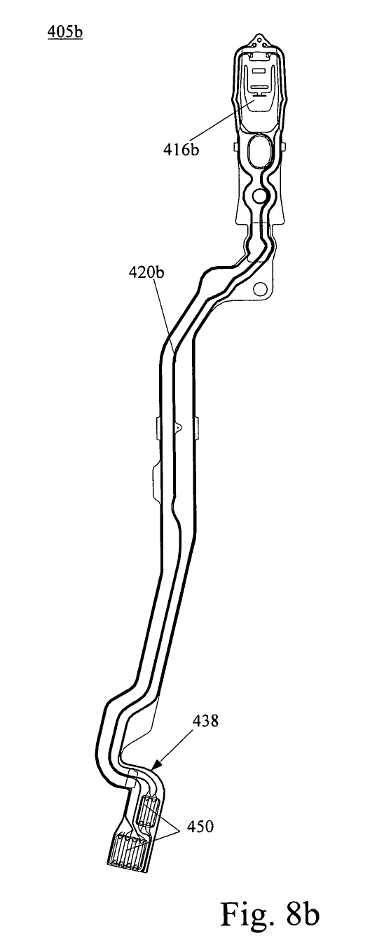

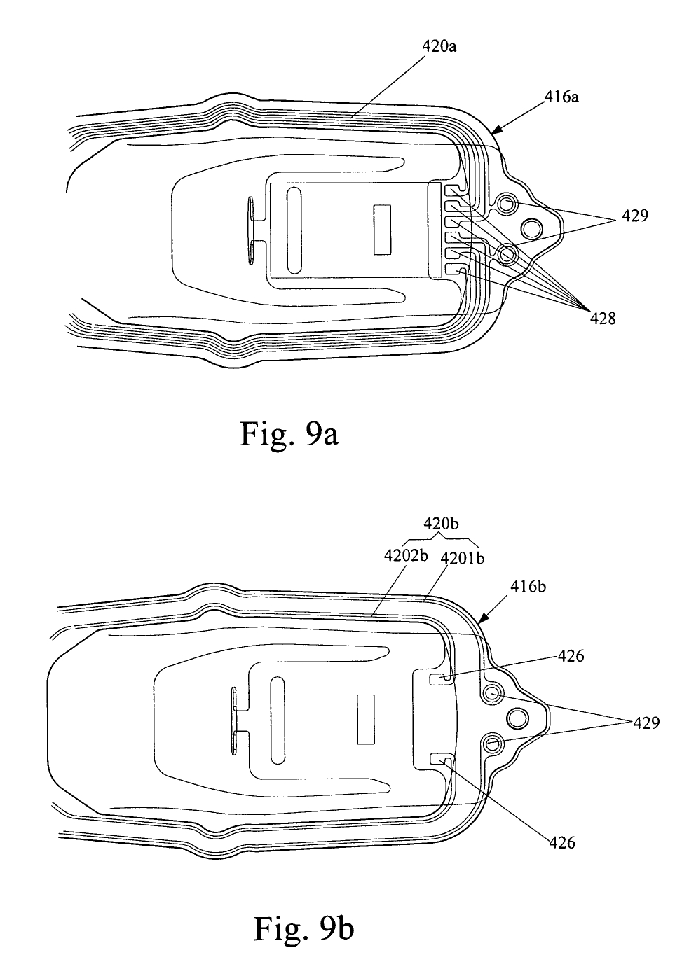

FIGS. 8a-8b and FIGS. 9a-9b illustrate a flexure of a suspension according to a third embodiment of the present invention. The main distinction between the third embodiment and the first embodiment is that the electrical traces 420 are formed on both the first surface 416a of the flexure 405 and the second surface 416b of the flexure 405. The first bonding pads 428 are electrically connected with the electrical traces 420a formed on the first surface 416a of the flexure 405, and the second bonding pads 426 are electrically connected with the electrical traces 4202b formed on the second surface 416b of the flexure 405. Besides, the copper joints 429 connect with the electrical traces 4201b and not joint with the second bonding pads 426. In another words, as shown in FIG. 9a-FIG. 9b, the electrical trace 4201b electrically connected to the electrical trace 420a. It is noted that the connection of the electrical trace 4201b and the electrical trace 420a has a different effect, supporting different functions to the slider and may further improve the slider flying performance. The electrical traces 420b connect to the bonding terminals 450 formed on the tail portion 438 of the flexure 405.

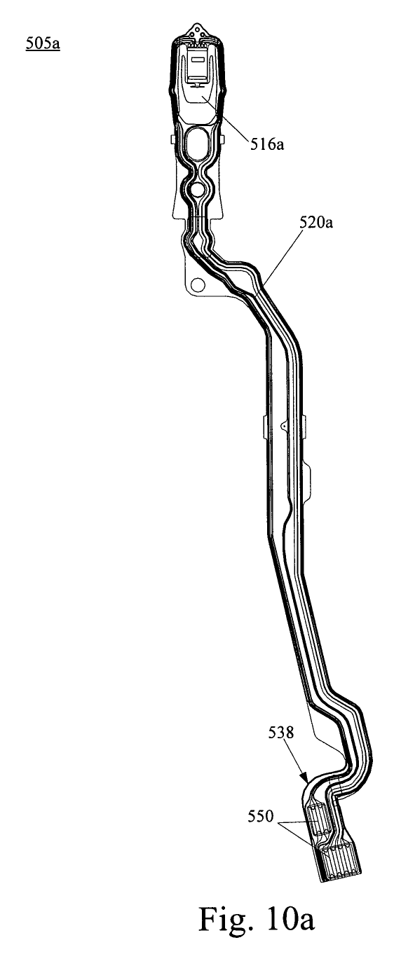

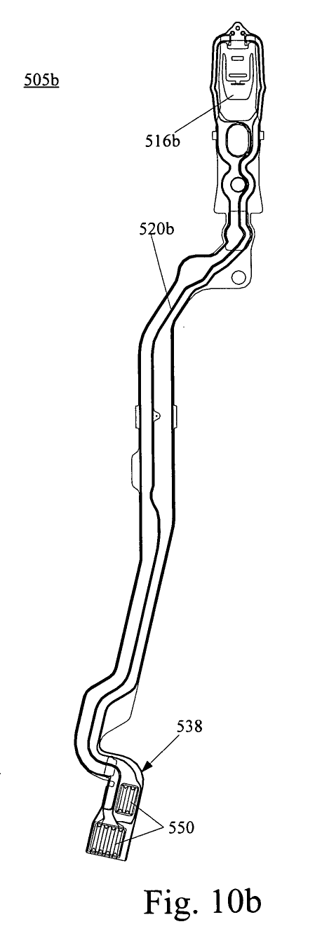

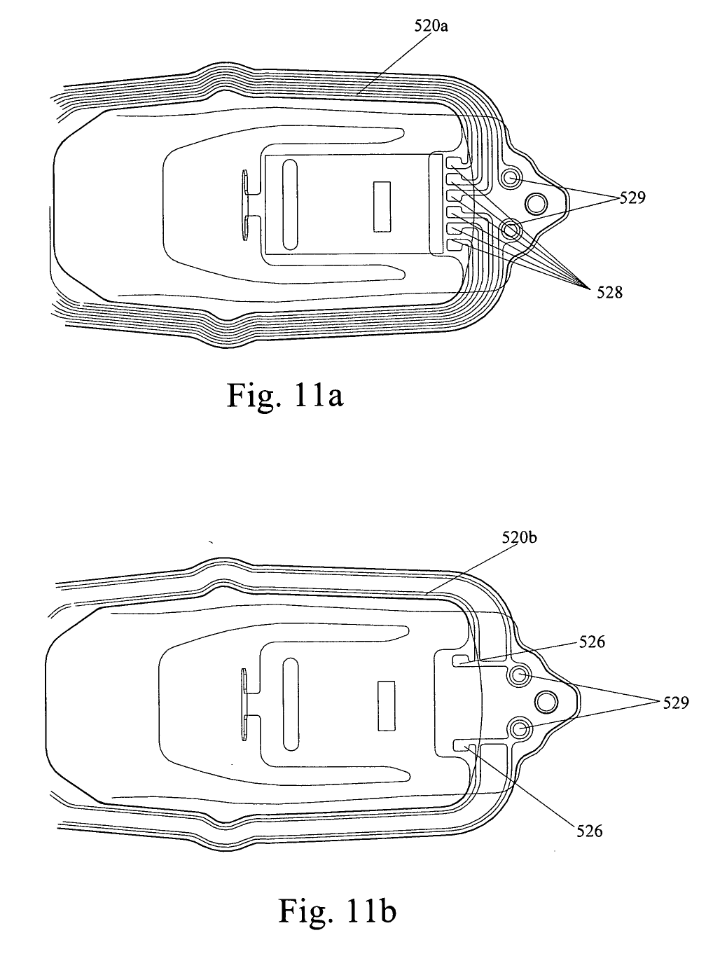

FIGS. 10a-10b and FIGS. 11a-11b illustrate a flexure of a suspension according to a forth embodiment of the present invention. There exists small difference between the flexure of the suspension of the forth embodiment and that of the third embodiment. In the forth embodiment, the second bonding pads 526 and the copper joints 529 electrically connect with the electrical traces 520b respectively while the second bonding pads 526 and the copper joints 529 are jointed together. However, in the third embodiment, the second bonding pads 426 disconnect with the copper joints 429. It is noted that the connection of the electrical trace 520b formed on the second surface 516b of the flexure and the electrical trace 520a formed on the first surface 516a of the flexure has a different effect, supporting different functions to the slider and may further improve the slider flying performance. The electrical traces 520b connect to the bonding terminals 550 formed on the tail portion 538 of the flexure 505.

Now, referring to FIG. 12, a HGA 200 according to an embodiment of the invention comprises a suspension 290 and a slider 203 carried on the suspension 290. The suspension 290 comprises a load beam 206, a base plate 208, a hinge 207 and the flexure 205, all of which are assembled with each other. The hinge 207 has a mounting hole 210 formed thereon to assemble the hinge 207 to the base plate 208. And then the slider 203 is carried on the flexure 205. It should be noted that the flexure 205 can be replaced by the flexure 305, 405, or 505 of the suspension according to the above-mentioned embodiments of the present invention.

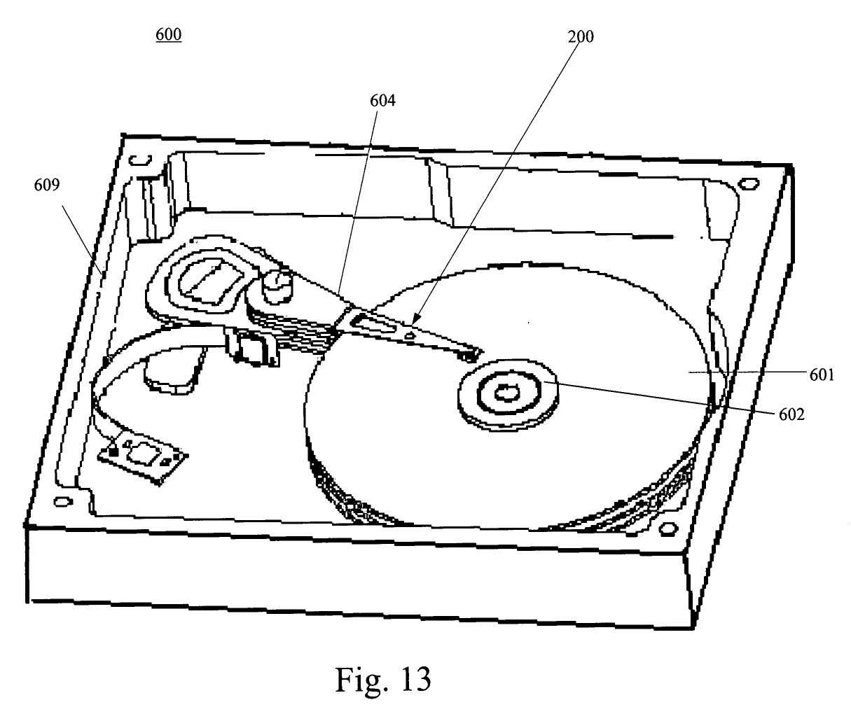

FIG. 13 is a disk drive unit according to an embodiment of the invention. The disk drive unit 600 comprises a HGA 200, a drive arm 604 connected to the HGA 200, a series of rotatable disks 601, and a spindle motor 602 to spin the disk 601, all of which are mounted in a housing 609. Because the structure and/or assembly process of disk drive unit of the present invention are well known to persons ordinarily skilled in the art, a detailed description of such structure and assembly is omitted herefrom.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A suspension for a head gimbal assembly, comprising:
a flexure having a plurality of electrical traces formed thereon, a plurality of first bonding pads formed on a first surface of the flexure and at least one second bonding pad formed on a second surface of the flexure opposite to the first surface, wherein the first bonding pads and the at least one second bonding pad are electrically connected with the electrical traces and adapted to electrically connect to a slider of the head gimbal assembly.

2. The suspension according to claim 1, wherein the electrical traces are formed on the first surface of the flexure, and the at least one second bonding pad is connected with the electrical traces by a conductive joint running through the flexure.

3. The suspension according to claim 2, wherein the conductive joint is copper joint.

4. The suspension according to claim 1, wherein the electrical traces are formed on both the first surface of the flexure and the second surface of the flexure, the first bonding pads are electrically connected with the electrical traces formed on the first surface of the flexure, and the at least one second bonding pad is electrically connected with the electrical traces formed on the second surface of the flexure.

5. The suspension according to claim 1, wherein the flexure further comprises a stainless steel layer between the first surface and the second surface of the flexure, and insulate layers formed between the stainless steel layer and the first surface and the second surface respectively.

6. The suspension according to claim 5, wherein the insulate layer is made of polyimide.

7. The suspension according to claim 1, wherein the flexure comprises two second bonding pads, and the two second bonding pads are symmetrical about a centerline of the suspension.

8. The suspension according to claim 1, wherein the flexure further comprises cover layers formed on the first surface and the second surface of the flexure, respectively.

9. A head gimbal assembly, comprising:
a slider;
a suspension with a flexure for supporting the slider,
wherein the flexure comprises a plurality of electrical traces formed thereon, a plurality of first bonding pads formed on a first surface of the flexure and at least one second bonding pad formed on a second surface of the flexure opposite to the first surface, and wherein the first bonding pads and the at least one second bonding pad are electrically connected with the electrical traces and electrically connect to the slider of the head gimbal assembly.

10. The head gimbal assembly according to claim 9, wherein the electrical traces are formed on the first surface of the flexure, and the at least one second bonding pad is connected with the electrical traces by a conductive joint running through the flexure.

11. The head gimbal assembly according to claim 10, wherein the conductive joint is copper joint.

12. The head gimbal assembly according to claim 9, wherein the electrical traces are formed on both the first surface of the flexure and the second surface of the flexure, the first bonding pads are electrically connected with the electrical traces formed on the first surface of the flexure, and the at least one second bonding pad is electrically connected with the electrical traces formed on the second surface of the flexure.

13. The head gimbal assembly according to claim 9, wherein the flexure further comprises a stainless steel layer between the first surface and the second surface of the flexure, and insulate layers formed between the stainless steel layer and the first surface and the second surface respectively.

14. The head gimbal assembly according to claim 13, wherein the insulate layer is made of polyimide.

15. The head gimbal assembly according to claim 9, wherein the flexure comprises two second bonding pads, and the two second bonding pads are symmetrical about a centerline of the suspension.

16. The head gimbal assembly according to claim 9, wherein the flexure further comprises cover layers formed on the first surface and the second surface of the flexure, respectively.

17. A disk drive unit, comprising:
a head gimbal assembly including a slider and a suspension that supports the slider;
a drive arm connected to the head gimbal assembly;
a disk; and
a spindle motor operable to spin the disk;
the suspension comprising:
a flexure having a plurality of electrical traces formed thereon, a plurality of first bonding pads formed on a first surface of the flexure and at least one second bonding pad formed on a second surface of the flexure opposite to the first surface,
wherein the first bonding pads and the at least one second bonding pad are electrically connected with the electrical traces and electrically connect to the slider of the head gimbal assembly.
